(19) United States
(12) Patent Application Publication
(10) Pub. No.: US 2020/0370330 A1
(43) Pub. Date: Nov. 26, 2020

(54) AIRCRAFT LATCH APPARATUS HAVING FLOATING STRIKE ASSEMBLY

(71) Applicant: Harper Engineering Co., Renton, WA (US)

(72) Inventor: Diego Valdes, Renton, WA (US)

(21) Appl. No.: 15/931,294

(22) Filed: May 13, 2020

Related U.S. Application Data
(60) Provisional application No. 62/850,372, filed on May 20, 2019.

(51) Int. Cl. E05B 15/02; B64D 11/00; E05B 85/04; E05B 83/16; E05C 19/12

(52) U.S. Cl. CPC E05B 15/022; B64D 11/003; E05B 85/04; E05Y 2900/538; E05C 19/12; E05Y 2900/502; E05B 83/16

(57) ABSTRACT

An aircraft door latch apparatus includes a stowage bin assembly having a door that is rotatably moveable between open and closed positions, and a frame structure. The aircraft apparatus includes a latch apparatus that is configured to couple and uncouple the door to the frame structure, the latch apparatus includes a floating strike assembly that pivotably adjusts to a deflection of the stowage bin assembly. Related methods are also provided.

### BACKGROUND

### Technical Field

The present disclosure generally relates to latches that couple/decouple aircraft interior components.

### Description of the Related Art

Aircraft interior components generally include latches that couple or decouple doors to frame structures of such components. For example, aircraft stowage bins include bin doors that are pivotably coupleable to stowage bin frame structures. Aircraft stowage bins can comprise various known designs, such as shelf bins, pivot bins, and translating bins. Shelf bins are generally positioned on outboard ends of an aircraft fuselage and the doors of such bins open outward and up. Pivot and translation bins tend to have a controlled rate of opening and the doors of such bins open out and down. Aircraft stowage bins generally include latch assemblies that are configured to allow doors to latch on to frame structures to couple or close the stowage bin, and unlatch the door from the frame structure to uncouple or open the stowage bin. In aircraft stowage bins, a latch component tends to misalign with a latch strike due, in part, to weight of the payload causing deflection or sagging of the frame structure and components thereof, for example the latch strike. Thus, as the latch component couples to the misaligned latch strike, such a coupled structure may add additional undesirable stresses and/or loads to the aircraft stowage bins and attaching aircraft structures.

### BRIEF SUMMARY

The various embodiments of stowage bin assemblies having latch apparatuses described herein provide apparatuses, assemblies, components and methods that reduce, limit, or mitigate undesirable stresses and/or loads of aircraft stowage bins and attaching aircraft structures. For example, in one example, non-limiting embodiment, an aircraft apparatus can be summarized as including a stowage bin assembly having a door that is rotatably moveable between open and closed positions, and a frame structure. The aircraft apparatus can include a latch apparatus configured to couple and uncouple the door to the frame structure, the latch apparatus including a floating strike assembly that pivotably adjusts to a deflection of the stowage bin assembly.

For example, in another example, non-limiting embodiment, a latch apparatus for coupling and uncoupling a stowage bin door to a frame structure can be summarized as including a latch component assembly having a latch member, and a floating strike assembly. The floating strike assembly can include an inner strike member, an outer strike member, and a strike member about which the inner strike member pivotably rotates relative to the inner strike member to self-align the strike member to the latch member.

For example, in another example, non-limiting embodiment, a method of aligning a stowage bin can be summarized as including deflecting a shelf of the stowage bin downwardly by positioning payload on the shelf to misalign a latch apparatus; pivotably moving a door of the stowage bin from an open position to a closed position; and self-aligning the latch apparatus by pivotably moving a floating strike assembly.

### BRIEF DESCRIPTION OF THE SEVERAL VIEWS OF THE DRAWINGS

FIG. 1 is an isometric view of an interior of an aircraft fuselage, partially illustrating a stowage bin assembly, according to one example, non-limiting embodiment.

FIG. 2 is a skewed front isometric view of a stowage bin assembly (with certain components removed for clarity of illustration and description) having a latch apparatus, according to one example, non-limiting embodiment.

FIG. 3 is a side view of the stowage bin assembly having the latch apparatus of FIG. 2 with certain components removed for clarity of illustration and description.

FIG. 4 is a cross-sectional view of the stowage bin assembly having the latch apparatus of FIG. 2, taken along line 4-4.

FIG. 5 is a partial, skewed isometric view of the stowage bin assembly having the latch apparatus of FIG. 2 with certain components removed for clarity of illustration and description.

FIG. 6 is a skewed, isometric view of a floating strike assembly of the latch apparatus of FIG. 2, according to one example, non-limiting embodiment.

FIG. 7 is another skewed, isometric view of the floating strike assembly of FIG. 6.

FIG. 8A is an exploded view of the floating strike assembly of FIG. 6.

FIG. 8B is another exploded view of the floating strike assembly of FIG. 6.

FIG. 9 illustrates a cross-sectional view of a stowage bin assembly having the latch apparatus taken along line 9-9 of FIG. 1, the stowage bin assembly being in a nominal configuration.

FIG. 10 illustrates a stowage bin assembly having the latch apparatus of FIG. 9, the stowage bin assembly being in a deflection configuration.

FIG. 11 illustrates a stowage bin assembly having the latch apparatus of FIG. 9, the stowage bin assembly being in a bin rotation configuration.

FIG. 12 illustrates a stowage bin assembly having the latch apparatus of FIG. 9, the stowage bin assembly being in a self-adjusted configuration.

### DETAILED DESCRIPTION

In the following description, certain specific details are set forth in order to provide a thorough understanding of various disclosed embodiments or implementations. However, one skilled in the relevant art will recognize that embodiments or implementations may be practiced without one or more of these specific details, or with other methods, components, materials, etc. In other instances, well-known structures associated with payload components, latches, aircraft stowage bins, or other systems and apparatuses of aircrafts have not been shown or described in detail to avoid unnecessarily obscuring descriptions of the embodiments or implementations.

Unless the context requires otherwise, throughout the specification and claims which follow, the word “comprise” and variations thereof, such as “comprises” and “comprising,” are to be construed in an open, inclusive sense, that is, as “including, but not limited to.”

Reference throughout this specification to “one embodiment,” “one implementation,” “an embodiment,” or “an implementation” means that a particular feature, structure or characteristic described in connection with the embodiment or implementation is included in at least one embodiment or implementation. Thus, the appearances of the phrases “in one embodiment,” “in one implementation,” “in an embodiment,” or “in an implementation” in various places throughout this specification are not necessarily all referring to the same embodiment or implementation. Furthermore, the particular features, structures, or characteristics may be combined in any suitable manner in one or more embodiments or implementations.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

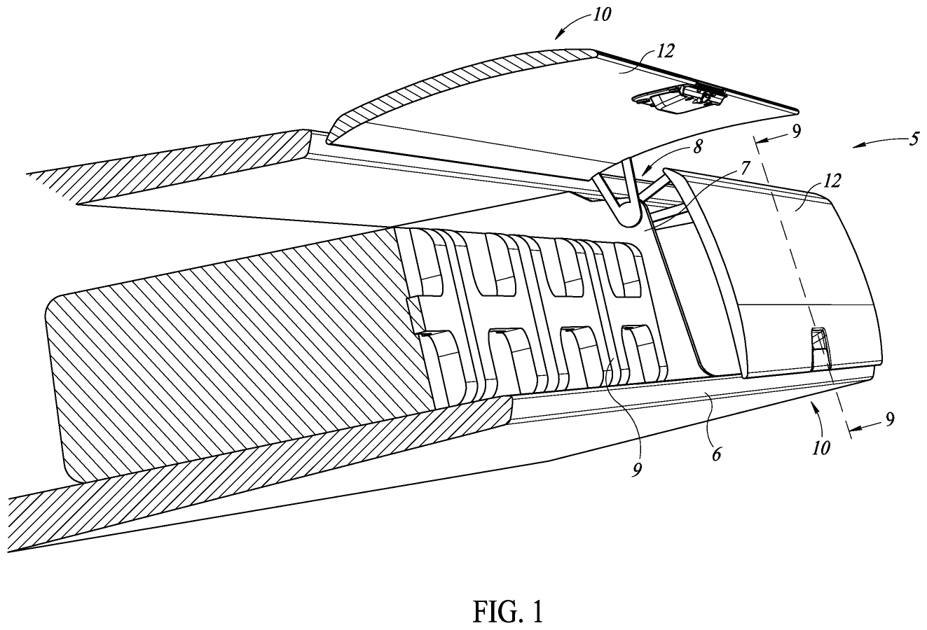

FIG. 1 generally illustrates portion of an interior 5 of an aircraft fuselage having a plurality of stowage bins 10, according to one example, non-limiting embodiment. The stowage bins 10 can take a wide variety of forms, and in one such form, as illustrated in FIG. 1, the stowage bins 10 can take the form of a shelf bin. The stowage bin 10 includes a door 12, a shelf 6, partition wall(s) 7, and hinge mechanism(s) 8. The shelf 6 is generally configured to receive payload, such as luggage 9. In this example embodiment, the door 12 pivotably moves between open and closed positions in an upward/downard direction relative to a longitudinal axis of the aircraft fuselage.

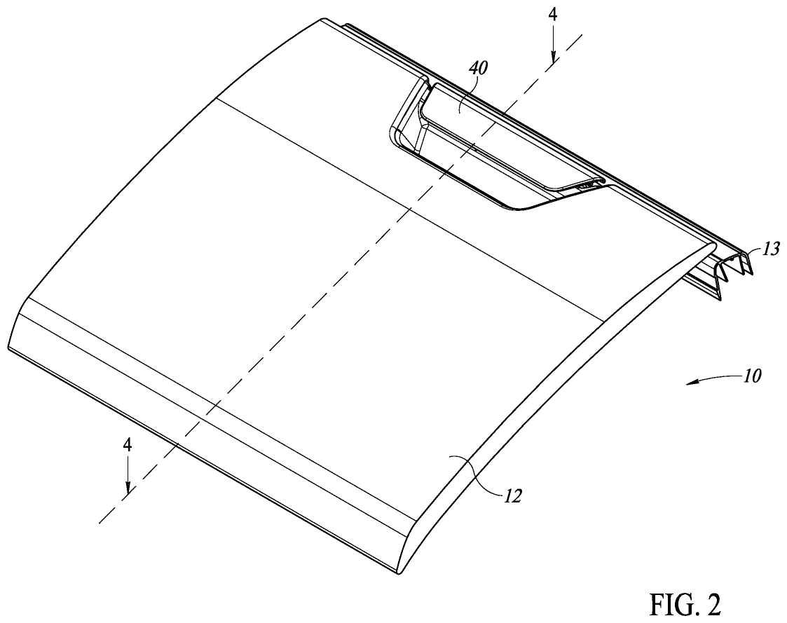

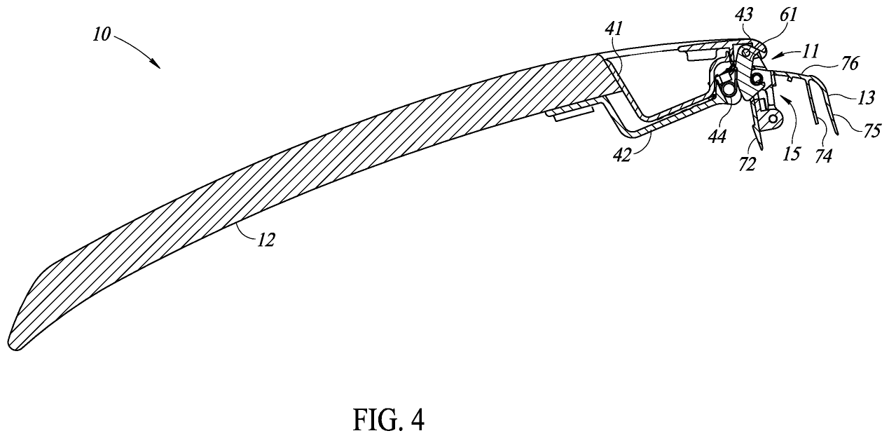

FIGS. 2-4 illustrate the stowage bin 10 (e.g., a shelf bin) having a latch apparatus 11, with certain components removed for clarity of illustration and description. The stowage bin 10 includes the door 12 that couples to a frame structure 13. The frame structure 13, in some embodiments, has a generally bull-nosed shape and structure having a first longitudinal flange 72, a second longitudinal flange 73, a third longitudinal flange 74, a fourth longitudinal flange 75, and a horizontal flange 76 coupled to the first, second, third, and fourth longitudinal flanges 72, 73, 74, 75. The frame structure 13 couples to the shelf 6, or in some embodiments may be integral with the shelf 6. The stowage bin 10 also includes a lever 40 that is pivotably coupled to the door 12 and pivotably moveable to latch and unlatch the stowage bin 10 from the frame structure 13, as described in more detail below. The stowage bin 10 includes a first coupling plate 41 and a second coupling plate 42 which are coupled to an interior side of the door 12 and include one or more pin(s) 43, biasing mechanism(s) 44 (e.g., springs) to pivotably the lever 40 to the door 12. The second coupling plate 42 includes a hook member 61 that has a generally hooked shaped structure and shape.

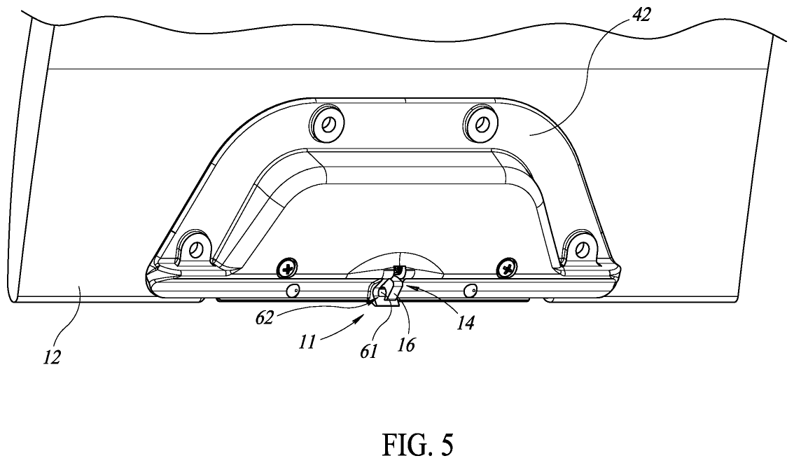

With reference to FIG. 5, which illustrates portions of the stowage bin 10 from an interior side of the stowage bin 10, and continued reference to FIGS. 2-4, the latch apparatus 11 includes a latch component assembly 14 that is coupled to the door 12 and a floating strike assembly 15 that is coupled to the frame structure 13. The latch component assembly 14 includes a latch member 16 that has a generally hook-shaped structure that latches or couples to the floating strike assembly 15. The hook member 61 of the second coupling plate 42 and the latch member 16, each having a generally hook-shaped structure and define a pin opening 62 through which strike member(s) may be received for the latch member 16 to latch or couple to, as described in more detail below. The floating strike assembly 15 is generally sized, shaped, and arranged to allow the latch component assembly 14 to couple, engage, or latch to the floating strike assembly 15 while relieving any loads or stresses caused by the deflection or sagging of the frame structure 13. In particular, the frame structure 13 is generally coupled to a bin bucket or a shelf, e.g., shelf 6, that houses payloads, e.g., luggage 9. As the bin bucket or shelf deflects or moves due to the weight of the payloads, such causes the frame structure 13 and the floating strike assembly 15 coupled thereto to move, deflect, or sag with the bin bucket or shelf Consequently, as the latch member 16 couples, engages, or latches to the floating strike assembly 15, in contrast to conventional strike assemblies which exert stresses or loads to account for the misalignment, the floating strike assembly 15 self-aligns to account for any misalignment.

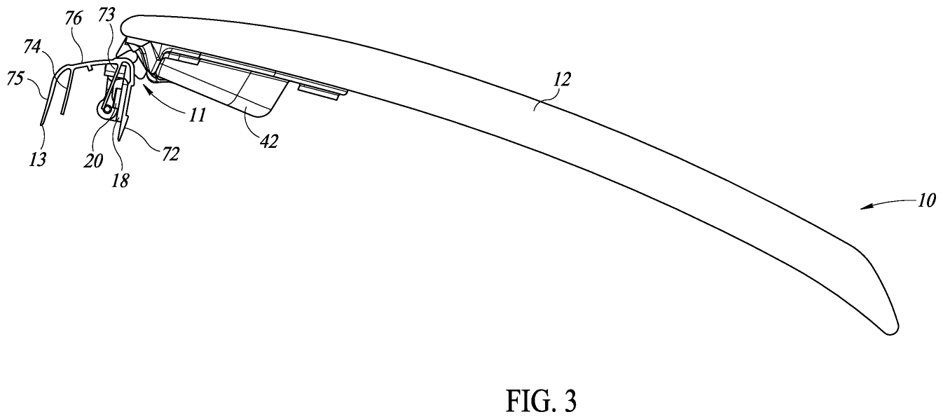

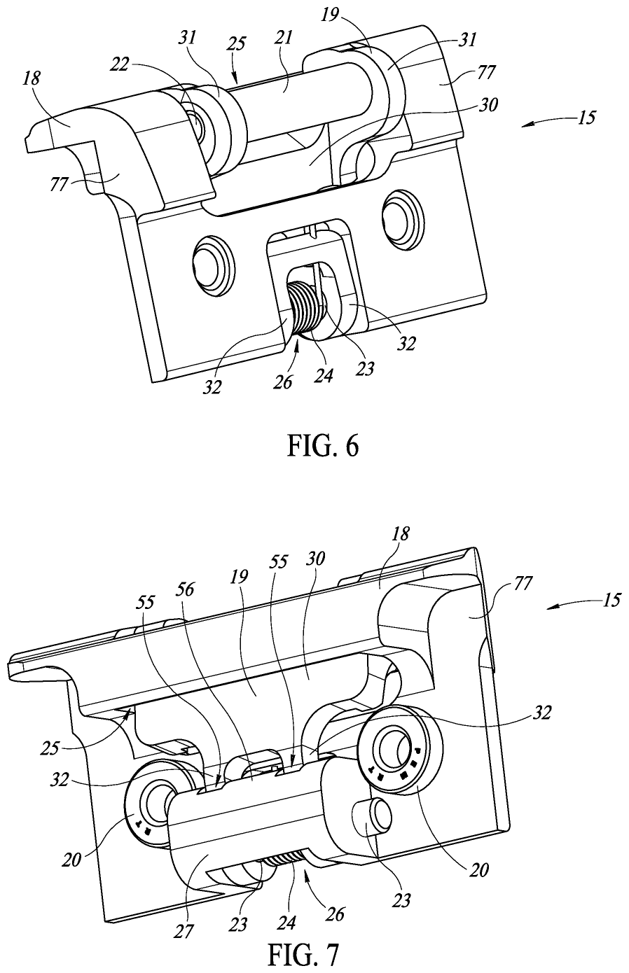

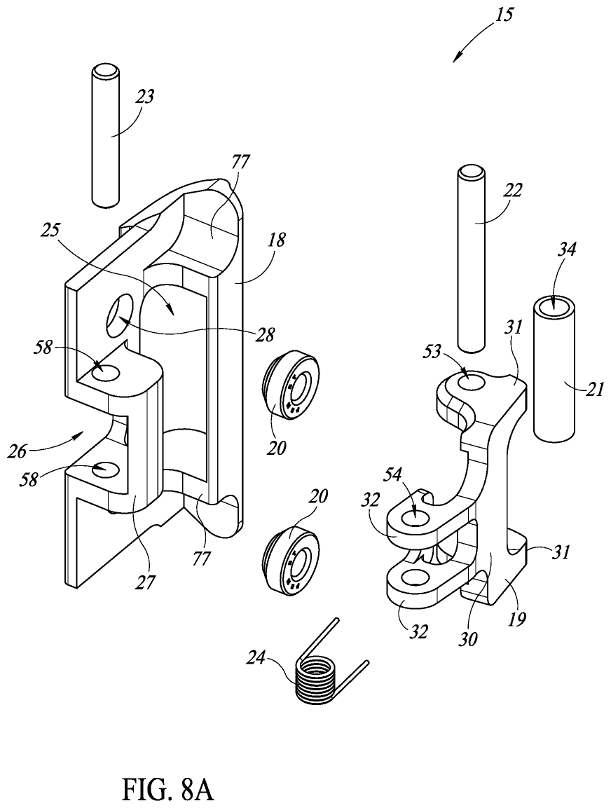

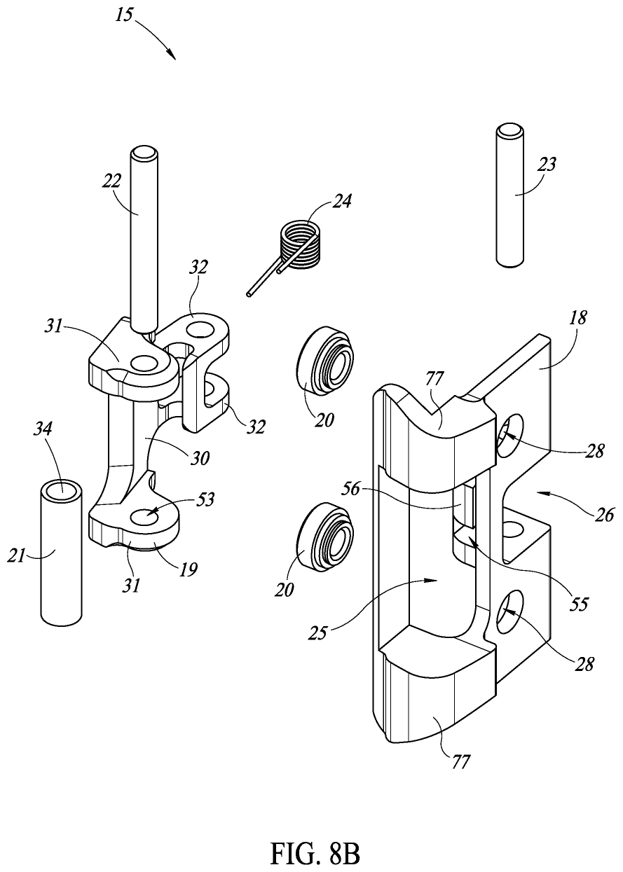

FIGS. 6-8B illustrate the floating strike assembly 15 in more detail. The floating strike assembly 15 includes an outer strike member 18, an inner strike member 19, one or more nuts 20 (e.g., lock-nuts), a strike element 21, a strike pin 22, a coupling pin 23, and an optional biasing device 24 (e.g., a torsion spring). The inner strike member 19 is generally sized and shaped to pivotably rotate with the respect to the outer strike member 18. The outer strike member 18 includes a first recess 25 provided between a pair of outer strike flanges 77 and a second recess 26 provided in a coupling member 27, and one or more coupling apertures 28. The coupling apertures 28 are sized and shaped to receive the one or more nuts 20. The coupling apertures 28 and the one or more nuts 20 fixedly couple the outer strike member 18 to the frame structure 13 via fasteners, or other similar coupling structures. For example, as illustrated in FIG. 3, the frame structure 13 is coupled to the floating strike assembly 15 via the one or more nuts 20 coupling to the outer strike member 18. In this manner, any movement of the frame structure 13 (e.g., via weight of payload) causes the outer strike member 18 to move with the frame structure 13.

The inner strike member 19 includes a main body 30, a pair of spaced apart strike flanges 31, and a pair of spaced apart pin flanges 32. The strike flanges 31 are received in the first recess 25 of the outer strike member 18 and include respective first apertures 53 sized and shaped to receive strike pin 22. The strike element 21 has a generally cylindrical shape and is annular having a strike pin aperture 34 that is sized and shaped to receive the strike pin 22. When received, the strike pin 22 extends through the strike pin aperture 34 and couples to the first apertures 53. The strike element 21 is sized and shaped to latch, engage, or couple to the latch member 16 of the latch component assembly 14, as described in more detail below.

The pin flanges 32 of the inner strike member 19 are received in the second recess 26 of the outer strike member 18 and include second apertures 54. In particular, the coupling member 27 includes a pair of spaced apart pin flange recesses 55 that define a central flange 56, and advantageously guide and secure the pin flanges 32. In particular, the pin flanges 32 are received in the pin flange recesses 55 and surround the central flange 56 of the coupling member 27. The coupling member 27 includes a pair of first receiving apertures 58 and the pin flanges 32 include the second apertures 54 that are each sized and shaped to receive the coupling pin 23. In particular, the coupling pin 23 pivotably couples the inner strike member 19 to the outer strike member 18.

Thus, if the frame structure 13 moves, deflects, or sags, and causes the outer strike member 18 to sag therewith, such may cause the strike element 21 to misalign from an optimal or nominal position at which the strike element 21 latches, engages, or couples to the latch member 16, as described in more detail below. As the latch member 16 latches, engages, or couples to the strike element 21 when misaligned from an optimal or nominal position, the inner strike member 19 pivotably rotates about or relative to the outer strike member 18 about a pivot axis defined by a center of coupling pin 23 to align with the latch member 16. The pivotable movement of the inner strike member 19 about or relative to the outer strike member 18 therefore accounts for any misalignment caused by movement of the outer strike member 18 and the strike element 21, which reduces, mitigates any loads or stresses caused by the coupling of the outer strike member 18 to the frame structure 13, for example, at interfaces of the outer strike member 18 and the frame structure 13, or loads or stresses caused to the latch component assembly 14 or interfaces of the latch component assembly 14 with the stowage bin assembly 10.

In some embodiments, the floating strike assembly 15 optionally includes the biasing device 24. The biasing device 24 is received in the coupling pin 23 and includes at least one end coupled to the inner strike member 19 and another end coupled to the outer strike member 18. The biasing device 24 is optionally provided to bias, e.g., spring-load, the inner strike member 19 and the strike element 21 to an ideal, nominal position. For example, as the inner strike member 19 pivotably moves about or relative to the outer strike member 18, the biasing device 24 may be configured to urge or bias the inner strike member 19 to return to an initial position, e.g., a position prior to the pivotable movement of the inner strike member 19.

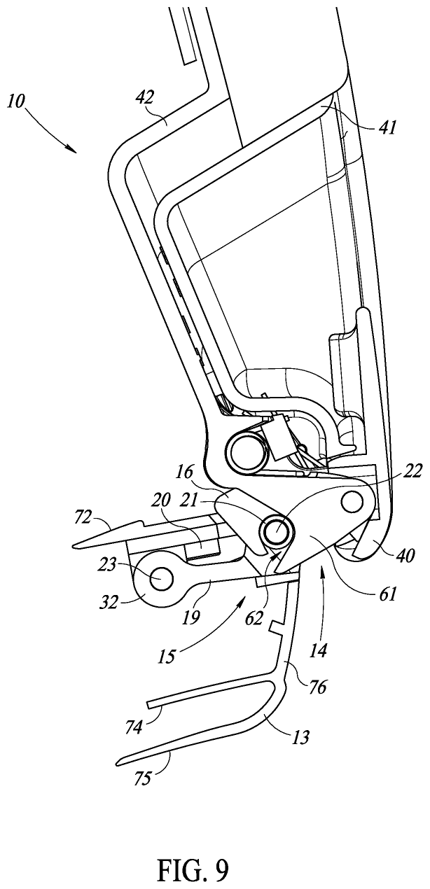

FIGS. 9-12 illustrate various operational configurations of the stowage bin assembly 10 having the latch apparatus 14. In particular, FIG. 9 illustrates a cross-sectional view of the stowage bin assembly 10 taken along line 9-9 in FIG. 1, when the stowage bin assembly 10 is in a closed position, with certain components, e.g., shelf 6, removed for clarity of illustration and description. The stowage bin assembly 10 in FIG. 9 is in a nominal configuration. In some embodiments, the nominal configuration may reflect minimal deflection of the shelf 6 or the frame structure 13. For example, in such a configuration the shelf 6 may not include any luggage 9, or payload with minimal weight. As illustrated, under normal operation or in the nominal configuration, the strike element 21 is located at an optimal position, and the latch member 16 contacts and couples, engages, or latches to the strike element 21, with the strike element 21 positioned in the pin opening 62.

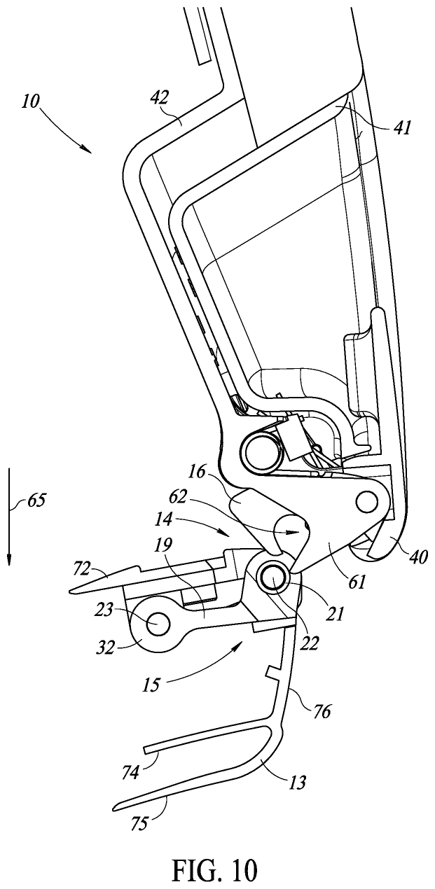

FIG. 10 illustrates the cross-sectional view of the stowage bin assembly 10, when the stowage bin assembly 10 is in a deflection configuration. In particular, if there is luggage 9 or other payload in or on the shelf 6, as described above, such can cause a deflection or movement of the frame structure 13, e.g., via luggage or other payload. Such deflection or movement can range anywhere from more than zero to approximately 0.2 inches in a downward direction indicated by arrow 65. In some embodiments, the deflection or movement can exceed 0.2 inches. As illustrated in FIG. 10, in the deflection configuration, the latch member 16 is misaligned from the optimal or nominal position illustrated in FIG. 9, and as a result, the strike element 21 is positioned away from the pin opening 62.

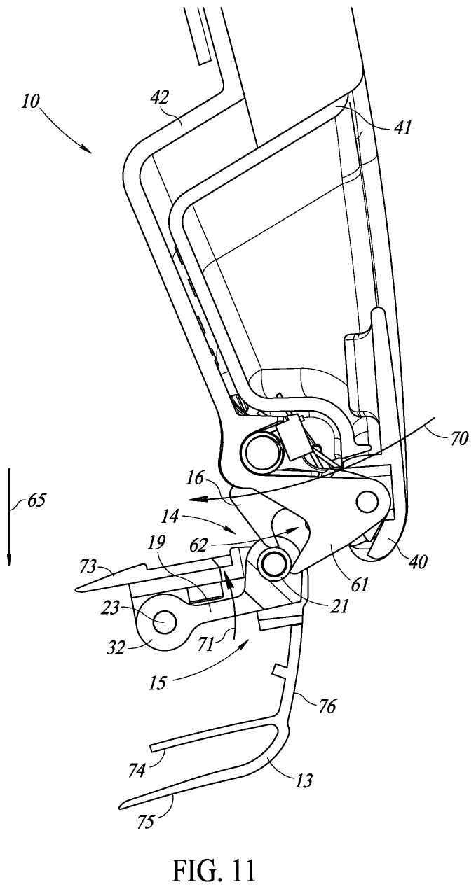

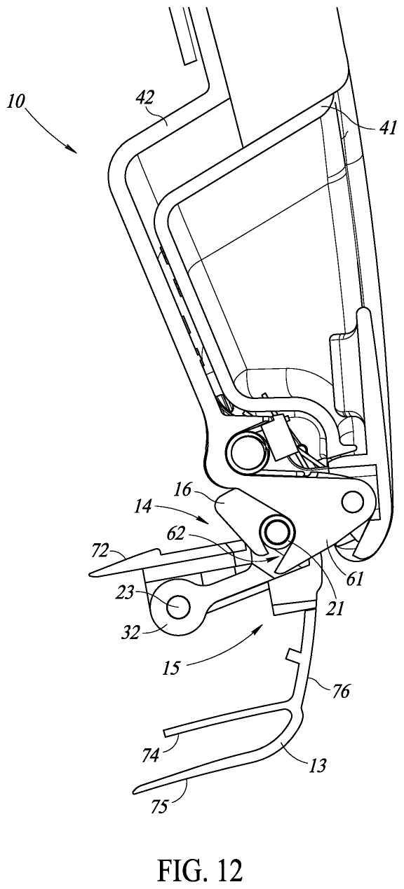

FIG. 11 illustrates the stowage bin assembly 10, when the stowage bin assembly 10 is in a rotation configuration. In particular, as a user rotationally moves the door 12 to close the stowage bin assembly 10, for example in a rotary direction indicated by arrow 70, and the stowage bin assembly 10 is in the deflection configuration illustrated in FIG. 10, such causes the latch member 16 and/or the hook member 61 to abut or contact the strike element 21. As the latch member 16 initially contacts the strike element 21, such causes the latch member 16 to rotate upward, while latch element 61 pulls the strike element 21 in an upward direction to account for the misalignment, deflection, or movement of the frame structure 13 (e.g., bullnose). The inner strike member 19, however, pivotably rotates about or relative to the outer strike member 18 via the coupling pin 23 in a rotary direction indicated by arrow 71. Such rotation causes movement of the strike element 21 along with the pivotable rotational movement of the inner strike member 19. FIG. 12 illustrates the stowage bin assembly 10, when the floating strike assembly 15 has moved into a self-adjusted configuration with the pivotable movement of the inner strike member 19 described above. In this configuration, the strike element 21 is positioned in the pin opening 62, and the frame structure 13 and the outer strike member 18 remain in their deflected position, and the latch apparatus 14 does not experience a downward load or stress. The stowage bin assembly 10, in the closed configuration, can be moved to the open configuration by unlatching the stowage bin assembly 10. For example, a user may pivotably rotate the lever 40, which would rotatably move the latch member 16 away from the pin opening 62, and disengage or unlatch the stowage bin assembly 10. Thereafter, a user may move the door 12 to the open configuration by pivotably rotating the door.

Moreover, the various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An aircraft apparatus, comprising:
a stowage bin assembly including:
a door that is rotatably moveable between open and closed positions; and
a frame structure; and
a latch apparatus configured to couple and uncouple the door to the frame structure, the latch apparatus including a floating strike assembly that pivotably adjusts to a deflection of the stowage bin assembly.

2. The aircraft apparatus of claim 1 wherein the floating strike assembly of the latch apparatus includes:
an outer strike member; and
an inner strike member, the inner strike member pivotably moveable relative to the outer strike member to adjust to the deflection of the stowage bin assembly.

3. The aircraft apparatus of claim 2 wherein the floating strike assembly includes a biasing device which is sized and shaped to urge the inner strike member to return to an initial position when the inner strike member pivotably moves relative to the outer strike member.

4. The aircraft apparatus of claim 2 wherein the outer strike member includes a recess provided between a pair of outer strike flanges, and the inner strike member includes a pair of spaced apart strike flanges received in the recess.

5. The aircraft apparatus of claim 4 wherein the strike flanges include apertures which are sized and shaped to receive a strike member.

6. The aircraft apparatus of claim 5 wherein the inner strike member is pivotably moveable relative to the outer strike member about a pivot axis defined by the strike member.

7. The aircraft apparatus of claim 1 wherein the frame structure comprises a bull-nosed structure defined by a plurality of longitudinal flanges coupled to a horizontal flange.

8. The aircraft apparatus of claim 1 wherein the latch apparatus further comprises one or more nuts, the one or more nuts sized and shaped to couple the floating strike assembly to the frame structure such that downward movement of frame structure moves the floating strike assembly downwardly therewith.

9. The aircraft apparatus of claim 1 wherein the latch apparatus includes a latch component assembly having a latch member.

10. The aircraft apparatus of claim 9 wherein the latch member has a hook-shaped structure, the latch member sized and shaped to latch and unlatch the door to the frame structure.

11. A latch apparatus for coupling and uncoupling a stowage bin door to a frame structure, the latch apparatus comprising:
a latch component assembly having a latch member; and
a floating strike assembly having:
an inner strike member;
an outer strike member; and
a strike member that defines a first pivot axis about which the inner strike member pivotably rotates relative to the outer strike member to self-align the strike member to the latch member.

12. The latch apparatus of claim 11 wherein the latch member has a generally hook-shaped structure which is sized and shaped to at least partially surround the strike member to latch the latch member to the floating strike assembly.

13. The latch apparatus of claim 11 wherein the outer strike member includes:
a pair of outer flanges;
a first recess located between the pair of outer flanges;
a coupling member; and
a second recess extending through the coupling member.

14. The latch apparatus of claim 13 wherein the inner strike member includes a pair of spaced apart strike flanges that are sized and shaped to be received in the first recess.

15. The latch apparatus of claim 14 wherein the inner strike member includes a pair of spaced apart pin flanges that are sized and shaped to be received in the second recess.

16. The latch apparatus of claim 15 wherein a coupling pin pivotably couples the pin flanges to the coupling member, the coupling pin defining a second pivot axis about which the inner strike member pivotably rotates relative to the outer strike member.

17. The latch apparatus of claim 11, further comprising:
a biasing device which is sized and shaped to urge the inner strike member to return to an initial position when the inner strike member pivotably moves relative to the outer strike member.

18. A method of aligning a stowage bin, comprising:
deflecting a shelf of the stowage bin downwardly by positioning payload on the shelf to misalign a latch apparatus;
pivotably moving a door of the stowage bin from an open position to a closed position; and
self-aligning the latch apparatus by pivotably moving a floating strike assembly.

19. The method of claim 18 wherein the self-aligning includes pivotably moving an inner strike member of the floating strike assembly relative to an outer strike member of the floating strike assembly.

20. The method of claim 18, comprising:
prior to self-aligning the latch apparatus, contacting a latch member of the latch apparatus with a strike member of the floating strike assembly.
